(19) United States
(12) Patent Application Publication
(10) Pub. No.: US 2024/0152359 A1
(43) Pub. Date: May 9, 2024

(54) ENSURING FAIRNESS FOR TRY SPIN LOCK

(71) Applicant: International Business Machines Corporation, Armonk, NY (US)

(72) Inventors: Lokesh Mohan Gupta, Tucson, AZ (US); Matthew G. Borlick, Tucson, AZ (US); Beth Ann Peterson, Tucson, AZ (US); Kyler A. Anderson, Sahuarita, AZ (US)

(21) Appl. No.: 17/981,183

(22) Filed: Nov. 4, 2022

(51) Int. Cl. G06F 9/30; G06F 9/52

(52) U.S. Cl. CPC G06F 9/3009; G06F 9/526

(57) ABSTRACT

In one general embodiment, a computer-implemented method includes detecting a thread attempting to acquire a TRY lock. A determination is made as to whether the thread has acquired the TRY lock. In response to the thread being unable to acquire the TRY lock within a predefined number of attempts to acquire the TRY lock, a number of attempts allowed is increased based on at least one predefined criterion. The thread is allowed to attempt to acquire a TRY lock within the increased number of attempts.

### BACKGROUND

The present invention relates to spin locks, and more specifically, this invention relates to adjusting parameters of a TRY lock mechanism for ensuring fairness for a spin lock.

A spin lock is a type of lock in which the implementation of lock acquire is to simply check if the lock is available repeatedly in a loop (“spin”). Since the thread remains active but is not performing a useful task, the use of such a lock is essentially a kind of busy waiting. Many high capacity storage systems such as the IBM® System Storage® D58000® series systems and the like use spin locks in various places to provide synchronized access to data.

There are several variations of spin locks, and some of the spin lock implementations do provide fairness. Many spin lock implementations also provide a “TRY” lock mechanism to try to acquire a lock but with a limited number of spins on the lock. As used herein, a “TRY lock” refers to a spin lock with an active TRY lock mechanism. If the lock is acquired within the specified number of spins, then the TRY lock succeeds. But if no lock is acquired upon completing the specified number of spins, then the TRY lock fails.

There are variety of reasons why a TRY lock may be used, one of them being to avoid deadlock. Many threads could be doing TRY locks at the same time. These threads could be doing TRY locks in a loop, and because there is no algorithm to ensure fairness, some of the threads will starve out trying to get TRY lock.

For example, usage of a TRY lock in the case below in a high capacity storage system will likely starve out some threads. The cache of the system keeps a list of Nonvolatile Storage Track IDs (NVS TIDs) for each modified metadata. The list is used, rather than storing all of the data from the metadata into NVS. The cache may attempt to keep the NVS TID list compact by moving the last entry in the TID list to the current entry being removed. Thus, when a process releases NVS TID, it needs to move the TID from the last position in the TID list to the new empty spot. The release process needs to get a Schedule Index Table (SIT) lock for the last track in the TID list. This SIT lock is taken in try mode since the process that requested release of the TID already has a Cache Directory Control Block (CDCB) lock on the track being released, and the track being released may be on the same SIT chain as the last track in the NVS TID list. Because the SIT lock is of a higher order than the CDCB lock, it can only be taken in TRY mode once the CDCB lock has already being taken. Once a SIT lock is obtained in the TRY lock mode, then the operation can be performed successfully by changing the track ID of the last track in the TID list.

The last track in the TID list is very busy with multiple Track Control Blocks (TCBs) taking metadata access. These metadata accesses will each try to acquire a SIT lock as well. Accordingly, there are too many processes that are trying to acquire a SIT lock on the last track in the TID list. Because a TRY lock does not guarantee fairness, and has a limited number of spins, many threads may get starved out trying and re-trying. For example, a thread that just started spinning might get the lock before another thread that has been spinning for over one million iterations. Another thread may try many times but never acquires a lock.

### SUMMARY

A computer-implemented method, in accordance with one embodiment, includes detecting a thread attempting to acquire a TRY lock. A determination is made as to whether the thread has acquired the TRY lock. In response to the thread being unable to acquire the TRY lock within a predefined number of attempts to acquire the TRY lock, a number of attempts allowed is increased based on at least one predefined criterion. The thread is allowed to attempt to acquire a TRY lock within the increased number of attempts.

A computer program product for managing TRY lock attempts, in accordance with one embodiment, includes one or more computer readable storage media, and program instructions collectively stored on the one or more computer readable storage media. The program instructions include program instructions to perform the foregoing method.

A system, in accordance with one embodiment, includes a processor; and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a flow diagram of a method, in accordance with one embodiment.

FIG. 4 is a flow diagram of a method, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for adjusting parameters of a TRY mechanism for ensuring fairness for a spin lock.

In one general embodiment, a computer-implemented method includes detecting a thread attempting to acquire a TRY lock. A determination is made as to whether the thread has acquired the TRY lock. In response to the thread being unable to acquire the TRY lock within a predefined number of attempts to acquire the TRY lock, a number of attempts allowed is increased based on at least one predefined criterion. The thread is allowed to attempt to acquire a TRY lock within the increased number of attempts.

In another general embodiment, a computer program product for managing TRY lock attempts includes one or more computer readable storage media, and program instructions collectively stored on the one or more computer readable storage media. The program instructions include program instructions to perform the foregoing method.

In another general embodiment, a system includes a processor; and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as TRY lock fairness code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

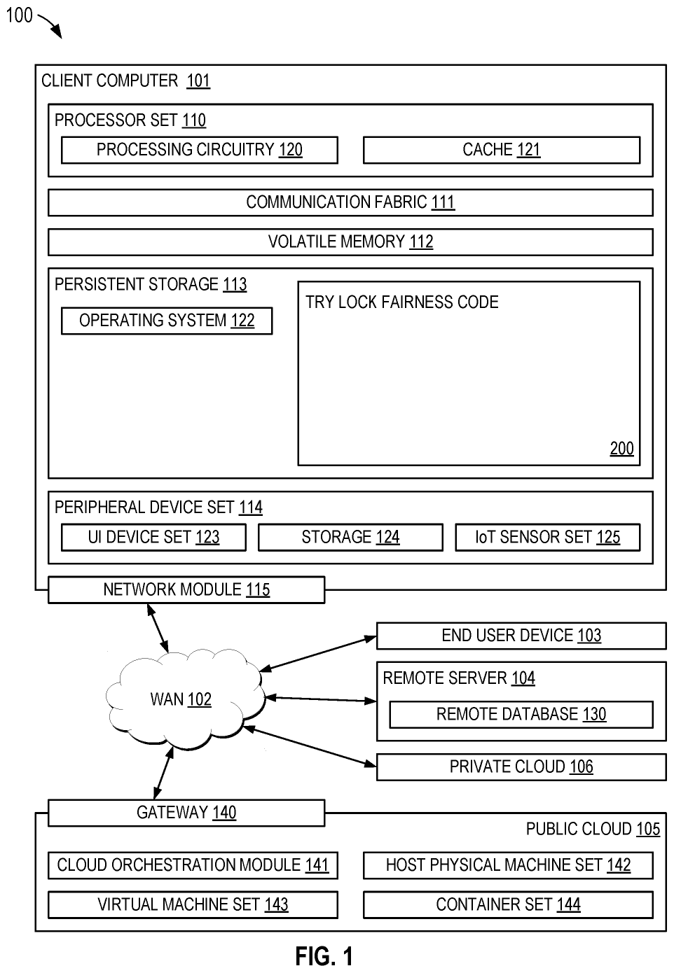

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

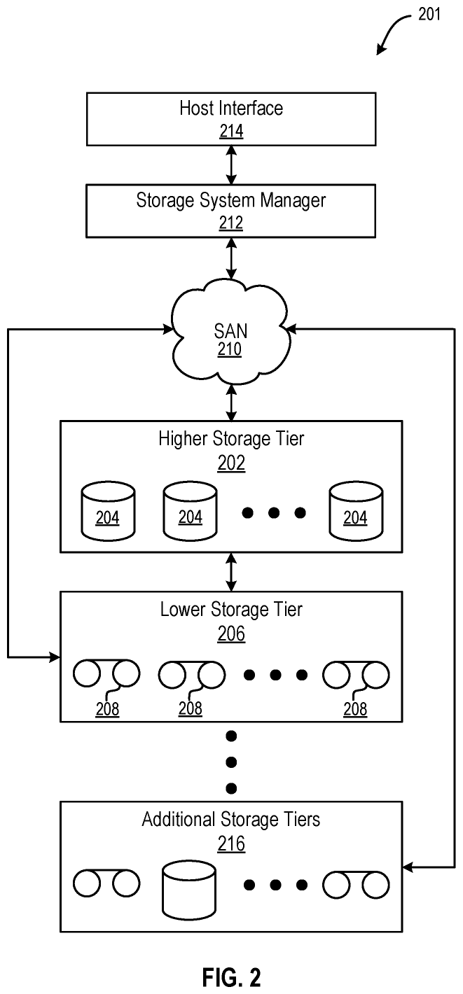

Now referring to FIG. 2, a storage system 201 is shown according to one embodiment. Note that some of the elements shown in FIG. 2 may be implemented as hardware and/or software, according to various embodiments. The storage system 201 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 201. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 201 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 201 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 201) may include logic configured to receive a request to open a data set, logic configured to determine if the requested data set is stored to a lower storage tier 206 of a tiered data storage system 201 in multiple associated portions, logic configured to move each associated portion of the requested data set to a higher storage tier 202 of the tiered data storage system 201, and logic configured to assemble the requested data set on the higher storage tier 202 of the tiered data storage system 201 from the associated portions.

Of course, this logic may be implemented as a method on any device and/or system or as a computer program product, according to various embodiments.

As noted above, use of TRY locks in conventional systems suffers from a lack of fairness. Where many threads are trying to obtain the lock, a thread that just started spinning might get the lock before another thread that has been spinning for over one million iterations. Similarly, another thread may try many times but is unlucky and never acquires a lock.

Presented herein is a methodology for providing fairness for TRY locks, by providing an increased chance of acquiring the lock to threads that have been spinning relatively longer than others.

In one general aspect, the number of spins is increased based on the length of time a thread has been active and has been looping for a TRY lock.

In another general aspect, the number of spins is increased based on a priority of the thread that is doing a TRY lock. For example, some threads may be assigned a higher priority, may need to acquire a lock more quickly than other processes, etc.

By increasing the number of spins allowed for a thread, the thread has a higher chance of obtaining the lock. In some cases, threads may be allowed to retry the TRY lock until they acquire the lock. This in turn ensures fairness for the TRY lock.

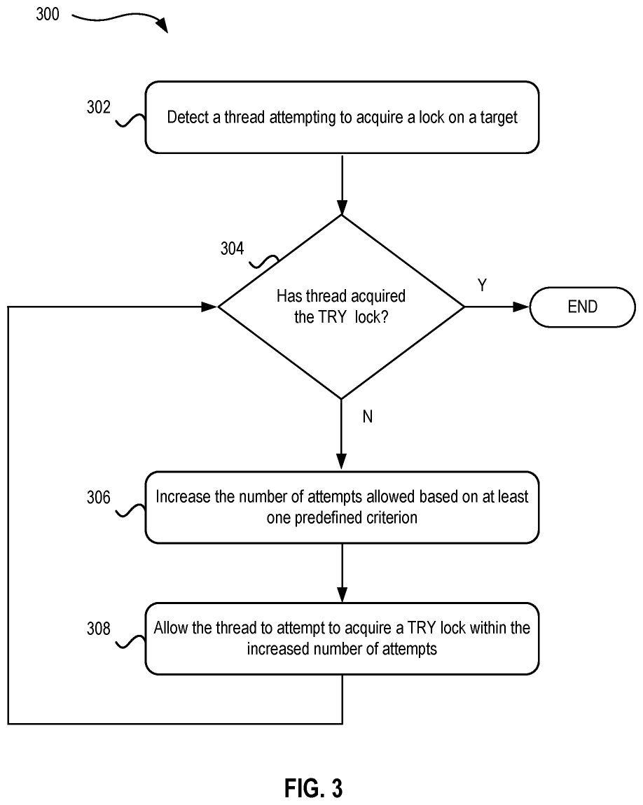

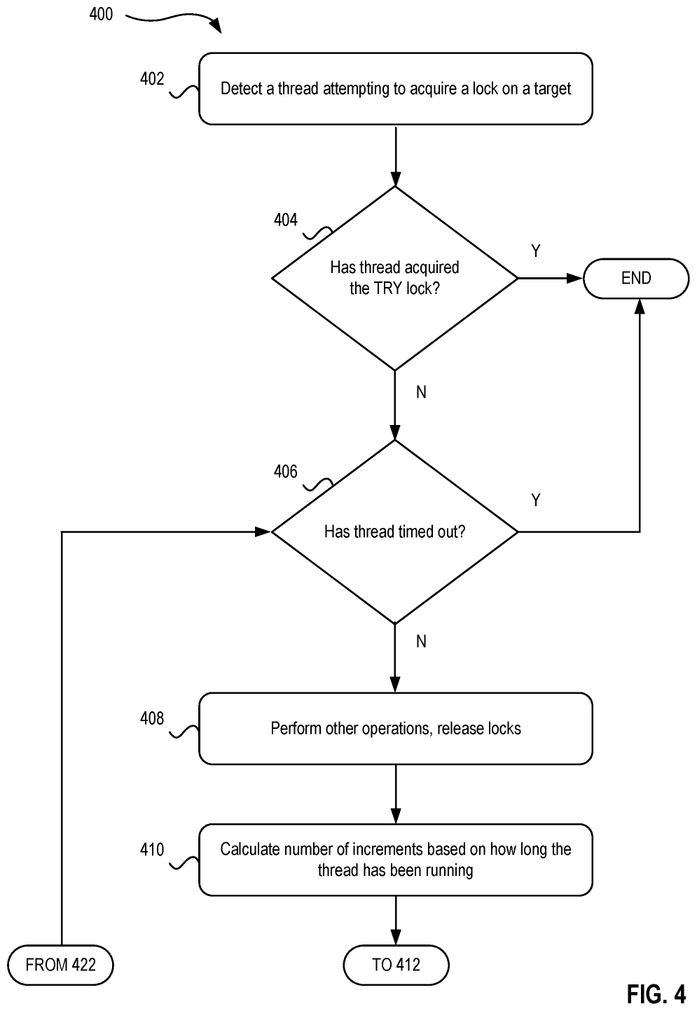

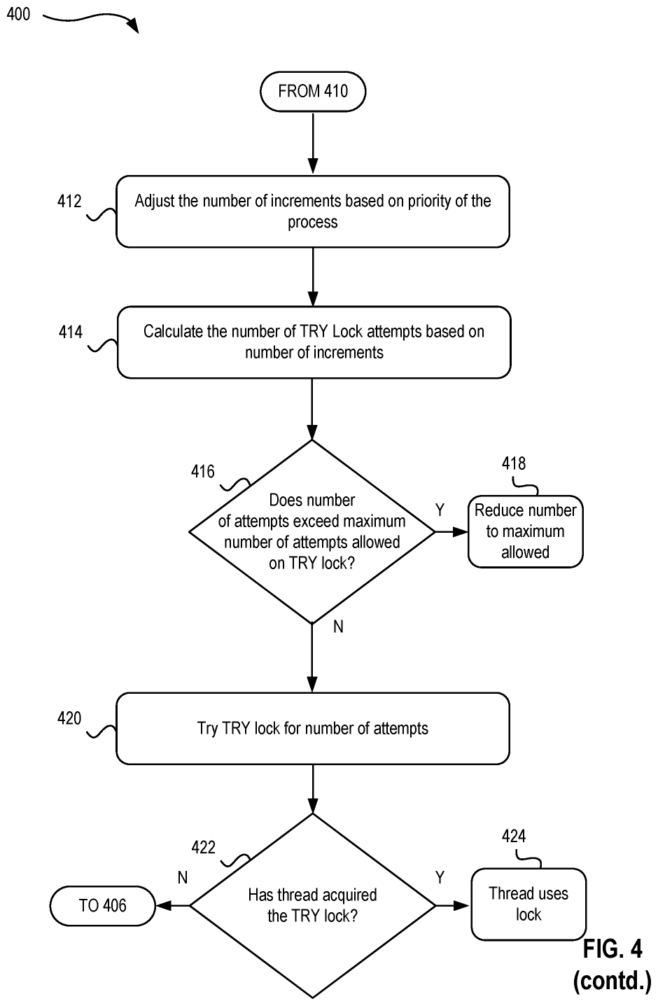

The processes of FIGS. 3 and 4 exemplify methodology for providing fairness for TRY locks.

Now referring to FIG. 3, a flowchart of a method 300 is shown according to one embodiment. The method 300 may be performed in accordance with the present invention in any of the environments depicted in FIGS. 1-2 and 4, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where a thread is detected attempting to acquire a lock on a target. The target may be any target that would become apparent to one skilled in the art upon reading the present disclosure. One example of a target is an NVS TID list.

In some aspects, the code specifies a TRY lock for the target. In other approaches, for locks corresponding to the process from which the threads originate, if the locks are taken in a reverse order, one or more of the locks may be specified as TRY locks.

At decision 304, a determination is made as to whether the thread has acquired the TRY lock. If the lock was acquired, the process 300 ends. If the lock was not acquired, the process 300 continues.

In operation 306, in response to the thread being unable to acquire the TRY lock within a predefined number of attempts to acquire the TRY lock, the number of attempts allowed is increased based on at least one predefined criterion.

In one approach, the at least one predefined criterion includes a length of time the thread has been running. In another approach, the at least one predefined criterion includes a priority of the thread. In yet another approach, the both the length of the time and the priority are used as criteria.

In operation 308, the thread is allowed to attempt to acquire a TRY lock within the increased number of attempts.

The process may then loop back to decision 304. If the thread is unable to acquire the TRY lock within the increased number of attempts, the increased number of attempts allowed is increased again based on the at least one predefined criterion. The thread is again allowed to attempt to acquire a TRY lock within the again increased number of attempts.

Now referring to FIG. 4, a flowchart of a method 400 is shown according to one embodiment. The method 400 may be performed in accordance with the present invention in any of the environments depicted in FIGS. 1-3, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a thread is detected attempting to acquire a lock on a target. The target may be any target that would become apparent to one skilled in the art upon reading the present disclosure. One example of a target is an NVS TID list.

In some aspects, the code specifies a TRY lock for the target. In other approaches, for locks corresponding to the process from which the threads originate, if the locks are taken in a reverse order, one or more of the locks may be specified as TRY locks.

At decision 404, a determination is made as to whether the thread has acquired the TRY lock. If the lock was acquired, the thread performs whatever operations it needs to perform using the lock, and the process 400 ends. If the lock was not acquired, the process 400 continues to a “TRY lock loop” that includes operations 406 to 422.

At decision 406, a determination is made as to whether the thread has timed out. If the thread has timed out, the process 400 ends. If the thread has not timed out, the process 400 continues.

In operation 408, other steps may be performed, such as acquire a lock on a lock that would cause deadlock with the TRY lock, and do the other things the thread would do under that lock. Upon completion of the operations using the other lock, the lock is released.

In operation 410, a number of increments is calculated based on how long the thread has been running. Any algorithm for making such a calculation that would become apparent to one skilled in the art after reading the present disclosure may be used. In one exemplary approach, the number of increments=(THREAD TIME*N)/Max Thread Time, where THREAD TIME is the time that the thread has already run, e.g., up to the present moment, up to approximately the start of the TRY lock loop, etc.; N is a predefined multiplication factor of any desired value, which may be selected or defined by the program, by a user, etc.; and the Max Thread Time is the maximum amount of time a thread is allowed to run before the thread times out. In an example, assume the thread has been spinning on the TRY lock for 500 milliseconds (ms), N=100, and the Max Thread Time is 2 seconds (2000 ms). The calculated number of increments is then 25.

In operation 412, the number of increments is adjusted based on the priority of the process doing the TRY lock. Any algorithm for making such an adjustment that would become apparent to one skilled in the art after reading the present disclosure may be used. In one exemplary approach, the number of increments=priority*number of increments from operation 410. The priority value can reflect any priority level (e.g., value) associated with the thread, and is preferably standardized to a priority scale applied to all threads attempting the TRY lock. The priority value may be predefined, selected by a user, defined by programming, etc. In some approaches, the priority values are predefined. In others, the priority values may be dynamically assigned based on predefined criteria that would become apparent to one skilled in the art upon reading the present disclosure. In one example, assume the priority level of the current thread is 10× the base priority level, as specified in the code of the software from which the thread originates. The priority value may thus be 10, and the number of increments may be increased by 10×. Applying this to the previous example, the number of increments is increased to 250.

In another approach, the priority is applied to some parameter to adjust the number of spins allowed for the thread, e.g., the priority is applied to the default number of spins for the TRY lock, without doing an adjustment for increasing the number of spins based on the length of time a thread has been active and spinning on the TRY lock. Likewise, in some approaches, priority is not considered in the process 400.

In operation 414, the number of TRY Lock attempts is calculated based on the number of increments calculated above. Any algorithm for making such a calculation that would become apparent to one skilled in the art after reading the present disclosure may be used. In one exemplary approach, numAttempts=Initial+(number of increments*Increment Value), where numAttempts is the number of attempts (spins) to obtain a lock; Initial is a number of initial spins, e.g., 60 spins or some other number; and Increment Value is the number of spins per increment, e.g., 50 spins per increment or some other number. The number of spins for Initial and Increment Value may be predefined, selected by a user, defined by programming, etc. Returning to the example above, the numAttempts for the exemplary thread would equal 60+(250*50), or 12,560 spins.

At decision 416, a determination is made as to whether the calculated number of attempts exceeds a maximum number of attempts allowed on the TRY lock. If the number of attempts exceeds the maximum number, then the number of attempts is reduced to the maximum number allowed in operation 418. Thus, for example, if the TRY lock has a maximum number of spins, such as 10 million spins, the numAttempts is reduced to 10 million spins if numAttempts exceeds that value.

In operation 420, the TRY lock is tried with the number of attempts.

At decision 422, if the TRY lock succeeds, then the thread breaks out of the loop and performs its operations using the lock. See operation 424.

If the TRY lock does not succeed, then the process returns to decision 406 (or operation 408 in some embodiments), and if the thread is still active per decision 406, the thread is allowed to perform other operations of any desired type in operation 408, such as acquiring a lock on locks that would cause deadlock with the TRY lock, and do the other things the thread would do under that lock. Then, the lock is released the remaining portion of the TRY lock loop is repeated. If the thread is timed out, then the thread may be reinitiated and the process 400 may be performed again.

The processes 300, 400 described herein ensure fairness for TRY locks, and variations thereof can also be used to ensure fairness with regular acquisition of spin locks. One advantage of using these processes 300, 400 over something like Ticket lock may be the ease of implementation and the relatively lower overhead of maintaining complex data structures.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
detecting a thread attempting to acquire a TRY lock;
determining whether the thread has acquired the TRY lock;
in response to the thread being unable to acquire the TRY lock within a predefined number of attempts to acquire the TRY lock, increasing a number of attempts allowed based on at least one predefined criterion; and
allowing the thread to attempt to acquire a TRY lock within the increased number of attempts.

2. The computer-implemented method of claim 1, comprising determining whether the thread has acquired the TRY lock within the increased number of attempts; increasing the increased number of attempts allowed based on the at least one predefined criterion in response to the thread being unable to acquire the TRY lock within the increased number of attempts; and allowing the thread to attempt to acquire a TRY lock within the again increased number of attempts.

3. The computer-implemented method of claim 1, comprising releasing another lock held by the thread prior to allowing the thread to attempt to acquire a TRY lock within the increased number of attempts.

4. The computer-implemented method of claim 1, wherein the at least one predefined criterion includes a length of time the thread has been running.

5. The computer-implemented method of claim 1, wherein the at least one predefined criterion includes a priority of the thread.

6. The computer-implemented method of claim 1, wherein the at least one predefined criterion includes both a length of time the thread has been running and a priority of the thread.

7. The computer-implemented method of claim 1, comprising determining whether the increased number of attempts exceeds a maximum number of attempts allowed for the TRY lock; and reducing the increased number of attempts to the maximum number in response to determining that the increased number of attempts exceeds the maximum number.

8. A computer program product for managing TRY lock attempts, the computer program product comprising:
one or more computer readable storage media, and program instructions collectively stored on the one or more computer readable storage media, the program instructions comprising:
program instructions to detect a thread attempting to acquire a TRY lock;
program instructions to determine whether the thread has acquired the TRY lock;
program instructions to, in response to the thread being unable to acquire the TRY lock within a predefined number of attempts to acquire the TRY lock, increase a number of attempts allowed based on at least one predefined criterion; and
program instructions to allow the thread to attempt to acquire a TRY lock within the increased number of attempts.

9. The computer program product of claim 8, comprising program instructions to determine whether the thread has acquired the TRY lock within the increased number of attempts; program instructions to increase the increased number of attempts allowed based on the at least one predefined criterion in response to the thread being unable to acquire the TRY lock within the increased number of attempts; and program instructions to allow the thread to attempt to acquire a TRY lock within the again increased number of attempts.

10. The computer program product of claim 8, comprising program instructions to release another lock held by the thread prior to allowing the thread to attempt to acquire a TRY lock within the increased number of attempts.

11. The computer program product of claim 8, wherein the at least one predefined criterion includes a length of time the thread has been running.

12. The computer program product of claim 8, wherein the at least one predefined criterion includes a priority of the thread.

13. The computer program product of claim 8, wherein the at least one predefined criterion includes both a length of time the thread has been running and a priority of the thread.

14. The computer program product of claim 8, comprising program instructions to determine whether the increased number of attempts exceeds a maximum number of attempts allowed for the TRY lock; and program instructions to reduce the increased number of attempts to the maximum number in response to determining that the increased number of attempts exceeds the maximum number.

15. A system, comprising:
a processor; and
logic integrated with the processor, executable by the processor, or integrated with and executable by the processor, the logic being configured to:
detect a thread attempting to acquire a TRY lock;
determine whether the thread has acquired the TRY lock;
in response to the thread being unable to acquire the TRY lock within a predefined number of attempts to acquire the TRY lock, increase a number of attempts allowed based on at least one predefined criterion; and
allow the thread to attempt to acquire a TRY lock within the increased number of attempts.

16. The system of claim 15, comprising logic configured to determine whether the thread has acquired the TRY lock within the increased number of attempts; logic configured to increase the increased number of attempts allowed based on the at least one predefined criterion in response to the thread being unable to acquire the TRY lock within the increased number of attempts; and logic configured to allow the thread to attempt to acquire a TRY lock within the again increased number of attempts.

17. The system of claim 15, comprising logic configured to release another lock held by the thread prior to allowing the thread to attempt to acquire a TRY lock within the increased number of attempts.

18. The system of claim 15, wherein the at least one predefined criterion includes a length of time the thread has been running.

19. The system of claim 15, wherein the at least one predefined criterion includes a priority of the thread.

20. The system of claim 15, comprising logic configured to determine whether the increased number of attempts exceeds a maximum number of attempts allowed for the TRY lock; and logic configured to reduce the increased number of attempts to the maximum number in response to determining that the increased number of attempts exceeds the maximum number.
